(19) United States
(12) Patent Application Publication
(10) Pub. No.: US 2022/0175157 A1
(43) Pub. Date: Jun. 9, 2022

(54) Bracket System for Retrofit of a Drop Shield to a Food Guard

(71) Applicant: Jose Orlando Matus, JR., Gainesville, GA (US)

(72) Inventor: Jose Orlando Matus, JR., Gainesville, GA (US)

(21) Appl. No.: 17/394,897

(22) Filed: Aug. 5, 2021

Related U.S. Application Data
(60) Provisional application No. 63/035,532, filed on Jun. 5, 2020.
(60) Provisional application No. 63/036,841, filed on Jun. 9, 2020.

(51) Int. Cl. A47F 10/06; E05D 3/02; E05D 5/06; E05D 11/10

(52) U.S. Cl. CPC A47F 10/06; E05D 3/02; E05D 5/0246; E05D 11/1078; A47F 2010/065; E05D 5/06

(57) ABSTRACT

A bracket system that allows a drop shield to be added to a prior art main viewing panel of a food guard. For instance, an existing food guard system can be modified to include a drop shield without having to make a permanent modification, or replacement, in order to close off “reach in” access to food stored beneath the food guard system. The system also reduces or eliminates any gap beneath the main viewing panel of the food guard and the upper edge of the drop shield.

### CROSS-REFERENCE TO RELATED APPLICATIONS

The present application is a non-provisional application claiming the benefit of the filing date of the U.S. Provisional Applications Ser. No. 63/035,532 filed on Jun. 5, 2020 and Ser. No. 63/036,841 filed on Jun. 9, 2020, both applications of which are hereby incorporated by reference in their entirety along with any and all exhibits and appendixes cited within these provisional applications.

### BACKGROUND

The present invention relates to systems and methods for food guard systems (sometimes called “sneeze guards”) and, more particularly, to a bracket system, and method for using the same, for retrofit of a drop shield to a main viewing panel of a food guard.

The spread of viruses and other pathogens in to and among the general public is a constant concern of the food service industry, particularly in cafeteria style, salad bar, and buffet style serving applications. Consequently, there is an almost ubiquitous use of food guards, or sneeze guards, to protect food from exposure to viruses and pathogens in cafeterias and buffets and self-service applications.

All food guard systems include at least a main viewing panel positioned to optimally protect the food from exposure, usually made of glass or clear plastic so that users can view the food but, the food is somewhat shielded from airborne contaminants launched by users breathing, sneezing, talking, yawning, or coughing while viewing or self-serving the food items. Commonly, the main viewing panel may be suspended at an angle above and in front of the staged food such that a user can easily reach under the main viewing panel (“reach in” access) and self-serve or receive a food portion being passed from a cafeteria worker.

A food guard is a tried and true solution for protecting exposed food in such applications, but in times when a particular, highly contagious virus is “going around,” such as was experienced during the 2020 coronavirus pandemic, food service establishments may desire to close off for an extended amount of time, the ability for patrons to reach in and gain access beneath the main viewing panel of food guard systems.

Replacement of an entire food guard system with a system that does not provide reach in access is not cost effective or desirable when the environmental conditions necessitating the replacement will be temporary. Similarly, permanent modification of a food guard system, such as drilling holes in a main viewing panel or modifying support structure to receive additional bracketry, is also undesirable both aesthetically and financially. And so, there is a need in the art for a bracket system that can be used to retrofit a drop shield to a main viewing panel of a food guard without requiring that the main viewing panel or the support structure of the food guard be modified. Additionally, there is a need in the art for such a bracket system that positions the drop shield such that any gap between the main viewing panel and the drop shield is minimized to prevent pass through of airborne viruses or pathogens.

### SUMMARY

Exemplary embodiments of a bracket system for retrofit of a drop shield to a main viewing panel of a food guard are disclosed. Certain embodiments are configured such that an existing food guard system does not require permanent modification, or replacement, in order to close off “reach in” access to food stored beneath the food guard system. It is a further advantage of certain embodiments of the solution that any gap defined beneath the main viewing panel of the food guard and the upper edge of the drop shield is set beneath and behind the leading edge of the main viewing panel, thereby mitigating or significantly reducing the probability that airborne pathogens may find their way to food stored beneath the food guard system.

An exemplary embodiment includes a system for attaching a drop down panel to a main viewing panel of an existing food guard system. The system includes a first attachment device that is configured to be secured to main viewing panel and a second attachment device secured to the drop down panel. Further, an adjustable hinge is configured to couple the first attachment device to the second attachment device such that the main viewing panel and the drop down panel can be moved, adjusted and held at a desired angle relative to each other. Advantageously, the first attachment device attaches to the main viewing panel that is positioned over an area to be protected, without having to modify the main viewing panel and/or its support system, and the second attachment device holds the drop down panel in front of an area such that access to the area and food items is restricted.

In some embodiments, the first attachment device includes a first holder that defines a first channel for receiving the main viewing panel. One side of the first holder includes one or more apertures that allow one or more securement elements to be inserted and then forced to apply pressure against the main viewing panel and thus, biasing the main viewing panel against an opposing side of the first holder to secure the first attachment device in position.

Similarly, in some embodiments, the second attachment device includes a second holder that defines a second channel for receiving the drop down panel. One side of the second holder includes one or more apertures that allow one or more securement elements to be inserted and then forced to apply pressure against drop down panel and thus, biasing the drop down panel against an opposing side of the second holder to secure the drop down panel in position.

In some embodiments, the second attachment device is fixedly attached to the drop down panel. Such attachment can be accomplished by adhesive, bolts, clamps etc. In these embodiments the drop down panel and the attachment devices can be sold as a unitary element.

In some embodiments, the adjustable hinge includes one or more flanges on the first attachment device and one or more flanges on the second attachment device. These flanges define an aperture. To assemble the first attachment device to the second attachment device, the flanges are interleaved such that the apertures are in alignment and, a rod or pin is inserted through the apertures. The rod can then be secured in position with one or more tightening nuts, clamps, pins, etc., such that the hinge can be secured together.

For some embodiments, the rod includes one or more nuts that can be tightened to secure the hinge in a particular position. Further, the second panel can be adjusted relative to the first panel by loosening the one or more nuts, pivoting the hinge to a new position, then re-tightening the nuts.

In some embodiments, the hinge may include a spring configured to bias the first attachment device towards a first position but still allow the first attachment device to be moved towards a second position.

Likewise, in some embodiments, the hinge may include a spring configured to bias the second attachment device towards a first position but still allow the second attachment device to be moved towards a second position.

In yet other embodiments, the hinge may include two springs. A first spring is configured to bias the first attachment device towards a first position but still allow the second attachment device to be moved towards a second position. Further, a second spring is configured to bias the second attachment device towards a third position but still allow the second attachment device to be moved towards a fourth position.

These and other embodiments are presented in more detail in the following drawings and accompanying detailed description.

### BRIEF DESCRIPTION OF THE DRAWINGS

FIG. 1 is a perspective view of an exemplary embodiment of a bracket for converting a current state of the art guard panel shield system into a no-access guard panel shield system.

FIG. 2A is an side-elevation view of an exemplary embodiment of a securement device that could be utilized in various embodiments of the no-access guard panel shield system.

FIG. 2B is a top-plan view of the proximate end of the securement device of FIG. 2A.

FIG. 3 illustrates another exemplary embodiment 200 of a bracket system for retrofit of a drop shield to a main viewing panel of a food guard, comprising a universal handed hinge aspect.

FIG. 4 is a conceptual diagram of a prior art permanent food guard installation with an embodiment of the no-access guard panel shield system installed.

FIG. 5 is a conceptual diagram of another embodiment of a no-access guard panel shield system.

FIG. 6 is another embodiment of a no-access guard panel shield system that includes one or more spring loaded attachment devices.

FIG. 7 is a conceptual diagram of another embodiment of the no-access food guard shield system.

### DETAILED DESCRIPTION

Various embodiments, aspects and features of the present invention encompass a bracket system for enabling the addition of a drop shield to a main viewing panel of a food guard.

In this description, the terms sanitizing and disinfecting, and their conjugants, are used interchangeably to refer to the functional goal of embodiments of the solution, namely, to mitigate exposure of food beneath a food guard system to harmful virus, pathogens debris or other forms of contamination.

In this description, the term “pathogen” refers to any bacterium, virus, contaminate or other microorganism that can cause disease to humans.

In this description, the terms “food guard,” “food guard system,” “sneeze guard” and the like are used interchangeably and refer to any system configured to present a barrier between the general public or consumers and food, drinks or other items staged on a serving table, bar or buffet.

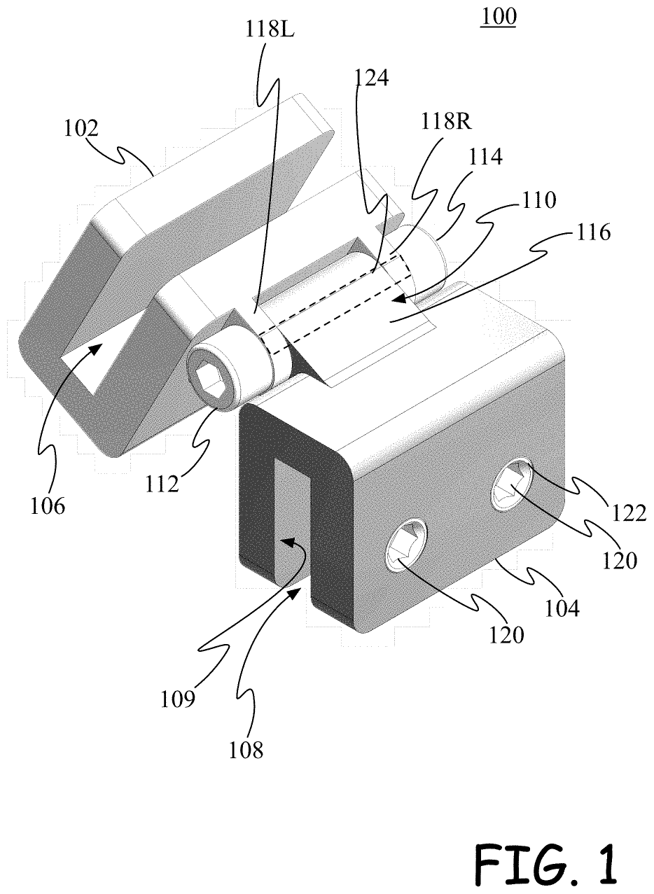

FIG. 1 is a perspective view of an exemplary embodiment of a bracket for converting a current state of the art guard panel shield system into a no-access guard panel shield system. The term no-access guard panel shield system refers to a guard panel system that not only provides a barrier against transmission of pathogens or bodily fluid transmitted through a sneeze, cough, sigh, breathing, talking etc., but also provides a barrier against reaching in to touch the food or to obtain food in a self-serve fashion. The illustrated bracket 100 includes a first attachment device 102 coupled to a second attachment device 104. In the illustrated embodiment, the first attachment device 102 and the second attachment device 104 are shown as being coupled with a hinged connection 110. The hinge may be attached to the first attachment device 102 and/or the second attachment device or, the hinge may be an integral part of one or both of the first and second attachment devices 102 and 104.

In the illustrated embodiment, the first attachment device 102 includes a slot, channel, chamber or cavity (referred to generally as a channel) 106 for receiving a first panel. The second attachment device includes a slot, channel, chamber or cavity (referred to generally as a channel) 108 for receiving a second panel. As best illustrated in the second attachment device, one or more clamping, securement or pressure devices 120 can be utilized to secure the a panel to the second attachment device. In the illustrated embodiment, the panel (not illustrated) can be slid into channel 108 and then secured in place by tightening the one or more securement devices 120. In a general embodiment, the securement devices 120 may be threaded elements that can be tightened such that an end of the threaded element can apply pressure against the inserted panel and thus forcing the panel against the interior wall 109 of the chamber 108. Once tightened, the panel is secured in position within the channel 108. Alternatively, the panel may include apertures through which the threaded element can pass through to secure the second panel in position with the channel 108. The same mechanism may also be utilized to secure the first panel within channel 106 of the first attachment device 102.

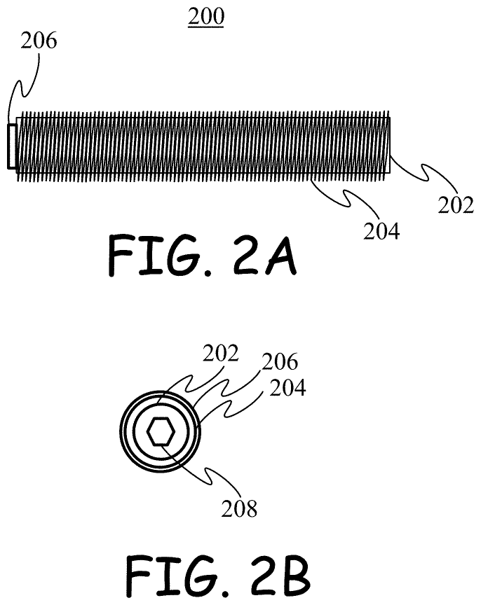

FIG. 2A is an side-elevation view of an exemplary embodiment of a securement device that could be utilized in various embodiments of the no-access guard panel shield system. FIG. 2B is a top-plan view of the proximate end of the securement device of FIG. 2A. The securement device 200 includes a core 202 that includes threads 204 extending over all or a portion of the core 202. The securement device 200 also includes a securement pad 206 at a distal end of the core 202 and a hex or other shaped adjustment mechanism 208 on a proximate end of the securement device 200. In operation, the securement pad 206 can be detached to the distal end of the core 202 and the distal end of the core can be threaded into an aperture (such as aperture 122 that receives securement device 120 in FIG. 1) and then the securement pad 206 can be re-attached to the distal end of the core 202. It should be appreciated that in some embodiments, the diameter of the securement pad 206 may be slightly less than the diameter of the threads 204 and thus, the securement pad 208 would not have to be removed and re-attached. In some embodiments the securement pads 206 may be rubber tips rubber or plastic coating, or the like on the end of the securement device 200, in order to prevent the securement device 200 from damaging the panel. As such, in embodiments that utilize the securement device 200 that applies pressure to hold the panel in position, it may not be necessary to modify a panel by drilling or boring holes. The brackets 104 and 106 “sandwich” onto the panels and hold them in position with friction. Further, the securement pad can be constructed of a material to enhance the friction against the panel. Likewise, the interior walls of the channel may be coated or surfaced in such a manner to also increase the friction and thus, more efficiently secure the panel in position.

Using the illustrated securement device 200 with the bracket 100, a panel, such as a glass panel, framed glass panel, panel with glass ports, etc. can be slid into the channel (such as channel 106 or 108) of the attachment device (such as first attachment device 102 or second attachment device 104) and then held in place by friction caused by tightening of the securement device 200 such that the securement pad 206 is pressed against the panel and the panel is pressed against an interior wall of the channel (such as interior wall 109 in channel 108) and thus held in position. In other embodiments, apertures may extend through the panel and the securement device 200 may then be tightened against the back wall of the channel (such as interior wall 109 in channel 108) thus holding the panel in position.

It should be appreciated that other mechanisms may be used to secure a panel within a channel of a securement device. Pins rather than threaded devices, clamps, protrusions and detents, glue, adhesives, using securement devices on opposing ends of a panel and connecting the securement devices with a rod or other mechanism, etc. These and other embodiments are also anticipated to be used in various embodiments of the no-access guard panel shield system.

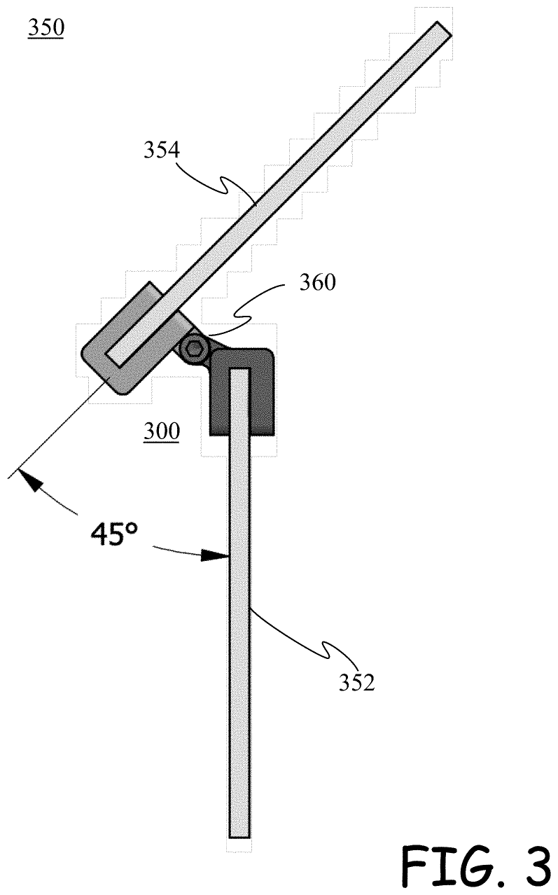

FIG. 3 is a conceptual drawing of an exemplary embodiment of a bracket system 300 utilized for adding a no-access drop shield 352 to a main viewing panel 354 of a food guard panel shield system 350. The exemplary embodiment illustrated in FIG. 3 has been applied to a food guard system with a main viewing panel set at 45 degrees relative to vertical. Other views of the exemplary embodiment can be seen in the above-incorporated U.S. Provisional Applications but, it should be appreciated to those skilled in the relevant art that by adjusting the universal handed hinge 360, a wide range of angles can be established. In one embodiment, the angle can be adjusted over a range of 0 degrees to 90 degrees. However, in other embodiments, the angle range may be less than 0 degrees and more than 90 degrees and in other embodiments the angle range may be more than 0 degrees and/or less than 90 degrees as well as other variations. As such, it will be appreciated, moreover, that certain embodiments of the hinged solution may be employed on any food guard system having a main viewing panel, or similar panel, regardless of the positioning of the main viewing panel relative to vertical. Exemplary embodiments of the solution as applied to main viewing panels in various positions relative to vertical can be seen in the above-incorporated U.S. Provisional Applications.

Returning to FIG. 1, the first attachment device 102 is illustrated as being coupled to the second attachment device 104 with a hinge type structure 110. In the illustrated embodiment, the first attachment device 102 and the second attachment device 104 comprise a universal handed hinge aspect. As one of ordinary skill in the art reviewing the FIG. 1 embodiment 100 would recognize, the hinge system 110 may be either a “left handed” hinge or a “right handed” hinge, depending on the orientation and application of the system 100.

The hinge structure 110 includes one or more flanges 116 extending from the second attachment device 104 and one or more flanges 118L and 118R extending from the first attachment device 102. In the illustrated embodiment, there is a single flange on the second attachment device 104 and it is sandwiched or inserted between the two flanges 118L and 118R on the first attachment device 102 in such a manner that the flange 116 from the second attachment device 104 can freely rotate or pivot relative to the one or more flanges 118L and 118R extending from the first attachment device 102. A pin or rod 124 is inserted through apertures 124 that run through the flanges 116, 118L and 118R and secured with a nut 112 on one end and a nut 114 on the other end to hold hinge structure 110 in place and the first attachment device 102 and second attachment device 104 relative to each other. Rather than a rod with two nuts, the rod may be structured as a bolt, threaded on one end to receive a nut and have a mounted or integral head on the other end. The hinge structure 110 may be in the form of a barrel hinge, a piano hinge, a door hinge, etc., such that the first attachment device 106 and second attachment device 104 may be pivotally articulated relative to one another. Advantageously, utilizing hinged embodiments, the first attachment device 106 and the second attachment device 104 may be mechanically fixed to a panel, such as panel 354 and 352 respectively in FIG. 3 and the panels can then be adjusted relative to each other. The embodiment of the bracket 100 illustrated in FIG. 1 may be preferred in certain applications as the hinged system 110 may be accessed and tightened from either side to adjust to orientation of the panels.

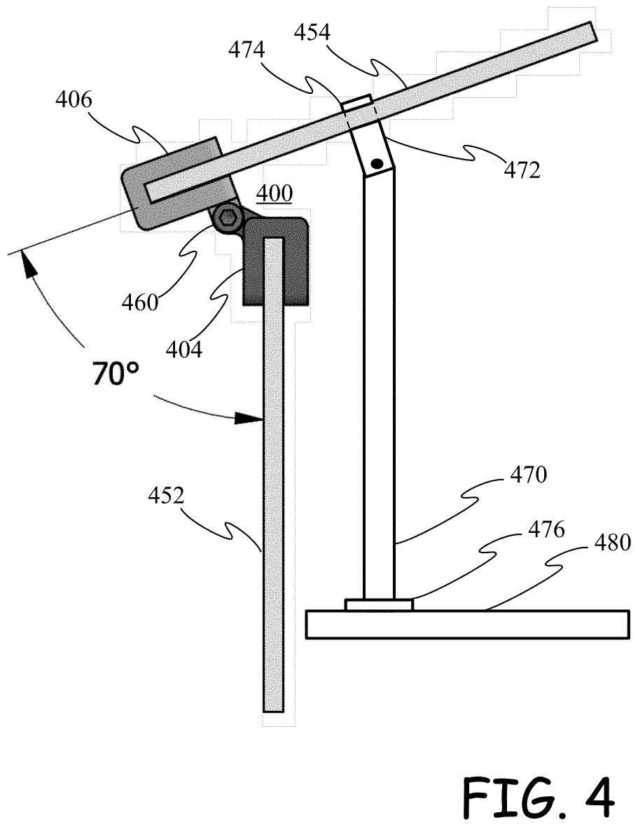

FIG. 4 is a conceptual diagram of a prior art permanent food guard installation with an embodiment of the no-access guard panel shield system installed. The prior art permanent food guard installation includes a main viewing panel 454 that is part of a permanent food guard installation. The main viewing panel 454 is mounted to post 470 utilizing a hinging or pivoting arm 472 that is mounted to the post 470, through the panel 454 and secured with cap 474 or some other technique. The post 470 then connects to base 476 which is then mounted to a surface 480, such as a table, serving system, etc. In some embodiments, the arm 472 may be at a fixed angle rather than adjustable. In the illustrated embodiment, the main viewing panel 454 is set at a 70 degree angle to the vertical. As would be understood by one of ordinary skill in the art, the space beneath the leading edge of the main viewing panel 454 may provide for open “reach in” access to food beneath the food guard. In certain times and events, it may be desirable to close off that access. To do so, upper bracket 406 may be installed on the leading edge of the main viewing panel 454 and secured in place via set screws or other means. A drop panel 452 may be similarly received into lower bracket 404. Advantageously, when the need to close off “reach in” access beneath the main viewing panel 454 has ended, the system 100 (and drop panel 452) may be removed from the food guard.

The hinge 460 may be leveraged to position the drop panel 452 into a substantially vertical orientation, thereby closing off any “reach in” access beneath the main viewing panel 454. In certain embodiments, the hinge 460 may be “free swinging” in order to allow the drop panel 452 to seek vertical via gravitational pull. In other embodiments, the hinge 460 may be configured to set and fix the lower bracket 404 at a desired angle relative to upper bracket 406 such that drop panel 452 cannot freely swing. Further, the hinge structure allows the drop panel 452 to be adjusted at an angle if necessary. For instance, if the surface 480 extends more towards to front edge of the main viewing panel 454, the drop down panel 452 may need to be angled away from the surface. Further, if the front edge of the main viewing panel 454 extends well beyond the front edge of the surface 480, a vertically oriented drop down panel 452 may result in a large gap between the front edge of the surface 480 and the drop down panel 452 such that one could reach under and contaminate the food, or air flow could cause dust and debris from the floor to enter into the food area. In such situations, the angle can be adjusted such that the drop down panel 452 is angled toward the front edge of the surface 480 to close such a gap.

Further, it is an advantage of certain embodiments of the solution that the position of the drop panel 452 is in a plane set back from the front edge of the main viewing panel 454, as can be understood from the illustrations. In this way, any gap between the upper edge of the drop panel 452 and the leading edge of the main viewing panel 454 is minimized and formed at a point well beneath the main viewing panel 454, thereby mitigating or significantly reducing any chances that airborne pathogens may find their way to food stored beneath the main viewing panel 454 and behind drop panel 452.

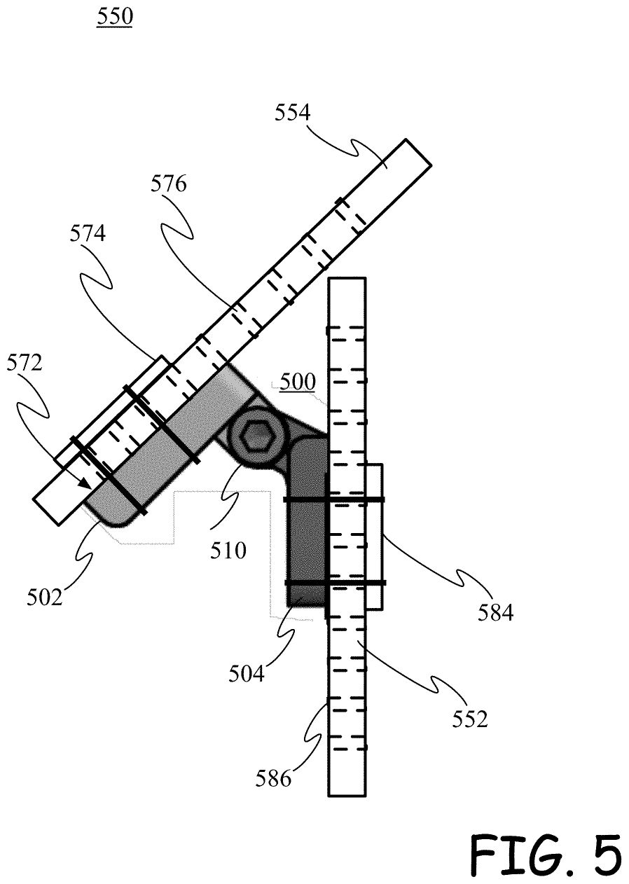

FIG. 5 is a conceptual diagram of another embodiment of a no-access guard panel shield system. In the illustrated embodiment, bracket 500 includes a first attachment device 502 coupled to a second attachment device 504. In the illustrated embodiment, the first attachment device 502 and the second attachment device 504 are shown as being coupled with a hinging connection 510. The first attachment device 502, rather than a slot, channel, chamber or cavity (as in element 106 of FIG. 1) includes a surface 572 for receiving the main viewing panel 554. The main viewing panel is illustrated as including a series of apertures 576, which could be a single row or multiple rows of apertures. When installing the main viewing panel 554, one or more of the apertures 576 are aligned with a connecting pin or bolt passing through or extending from the attachment device 502, through the one or more apertures 576 of the main viewing panel 554 and into a securement plate 574. Similar to the embodiment in FIG. 1, this structure will hold the main viewing panel 554 in position. However, the advantage of this embodiment is that the main viewing panel 554 can be adjusted up or down between various settings with the granularity of the setting being determined by the proximity of the apertures 576. Similarly, the second attachment device 504, rather than a slot, channel, chamber or cavity (as in element 104 of FIG. 1) includes a surface 582 for receiving a drop down panel 552. The drop down panel 552 is illustrated as including a series of apertures 586, which could be a single row or multiple rows of apertures. When installing the drop down panel 552, one or more of the apertures 586 are aligned with a connecting pin or bolt passing through the attachment device 504, through the one or more apertures 876 of the drop down panel 552 and into a securement plate 584. Similar to the embodiment in FIG. 1, this structure will attach to the main viewing panel 552 and be held in a desired position. However, the advantage of this embodiment is that the drop down panel 552 can be adjusted up or down between various settings with the granularity of the setting being determined by the proximity of the apertures 586.

The embodiment of FIG. 5 allows more flexibility in the adjustment and configuration of the main viewing panel and the drop down panel. For the apertures 576 on the main viewing panel 554 and apertures 586 on the drop down panel 552 that are not utilized, a plastic, silicone or other plug may be used to prevent the ingress of airborne particles from passing through the barrier.

The benefits of the embodiment illustrated in FIG. 5 may also be attained as a retrofit to an existing guard system. For instance, the bracket can be constructed to include a first attachment device 102 as depicted in FIG. 1 and a second attachment device 504 as depicted in FIG. 5. In such an embodiment, the bracket can be attached to an existing guard system without requiring any modifications to the existing system but, the adjustability of the embodiment of FIG. 5 can be utilized for the drop down panel.

In some embodiments, it can be appreciated that the first and second attachment devices, such as first attachment device 102 in FIG. 1 or 502 in FIG. 5 and second attachment device 104 in FIG. 1 or 504 in FIG. 5 and be adjustable relative to the hinge 110 in FIG. 1 or 510 in FIG. 5. In such embodiments, the attachment devices can be slid up and down relative to the hinge for the distance or length of the attachment devices. In such embodiments, the hinge elements may include one or more rails and the attachment devices can slide up and down the rails and then be secured into a set position with a set screw, clamp, etc. In such an embodiment, it will be appreciated that the drop down panel can be adjusted to minimize the gap between the main viewing panel and the drop down panel.

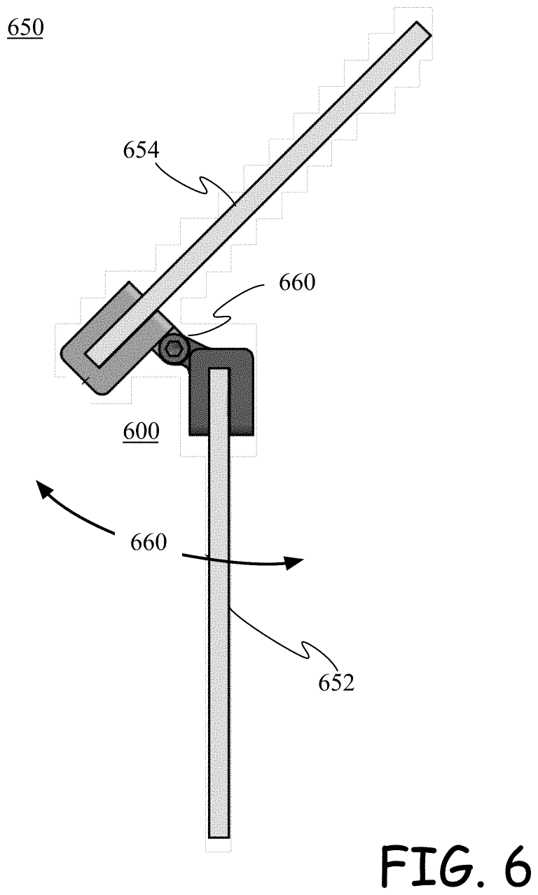

FIG. 6 is another embodiment of a no-access guard panel shield system that includes one or more spring loaded attachment devices. In the illustrated embodiments, a spring or coil is utilized to encourage or bias the panel into a resting state, such as the state represented in FIG. 6. The spring can be integral to the hinge 660 or external. In such embodiments, the hinge 660 is free to open and close but also includes a stopped position for the resting state. In operation, a user can grab a panel and force it into an open position for cleaning, loading new items into the serving area, etc., and then when the user releases the panel, the spring forces the panel back into the resting state. In the illustrated embodiment one or both of main viewing panel 654 and drop down panel 652 may be spring loaded to allow users to have quick access. In some embodiments the hinge 660 may be double springed, similar to a commercial kitchen door or saloon door that allows the door to swing open either direction but is biased to the closed state if no pressure is being applied. As such, one or more of the panels in FIG. 6, could be double springed to allow a user to either raise or lower the panel for cleaning and access but the panel returns to its resting space once the user releases the panel.

It should be appreciated that a hybrid approach of FIG. 3 and FIG. 5 can also be created. In such a hybrid, the first attachment device may include the channel structure of FIG. 1, whereas the second attachment device may utilize the structure of FIG. 5 or may be permanently attached to the second panel with screw, adhesive, etc. In such embodiments, a drop down panel and second attachment device may be purchased already assembled. In this case, the user simply attaches the first attachment device to the existing main viewing panel of an already established guard system. Further, these embodiments may be manufactured and sold in particular lengths.

Further, in the spring loaded embodiments, the hinges may also include a locking mechanism that will hold the panel into an open position. Once the locking mechanism is released, the panel returns to the resting state. The locking mechanism can be a pin used to hold the hinge a particular location or may be spring gear and cog system that automatically locks when the panel is lifted, and then unlocks again when the panel is again lifted. Those skilled in the art will be aware of this type of locking mechanism as well as many other such locking mechanisms.

In various embodiments, the attachment location of the hinge to the first and second attachment devices may vary. In the embodiments illustrated thus far, the hinge associates a top right corner of the first attachment device with the top left corner of the second attachment device. However, in other embodiments the hinge can actually be located at different locations, such as the bottom right corner of the first attachment device, bottom left corner of second attachment device, top of the second attachment device, etc.

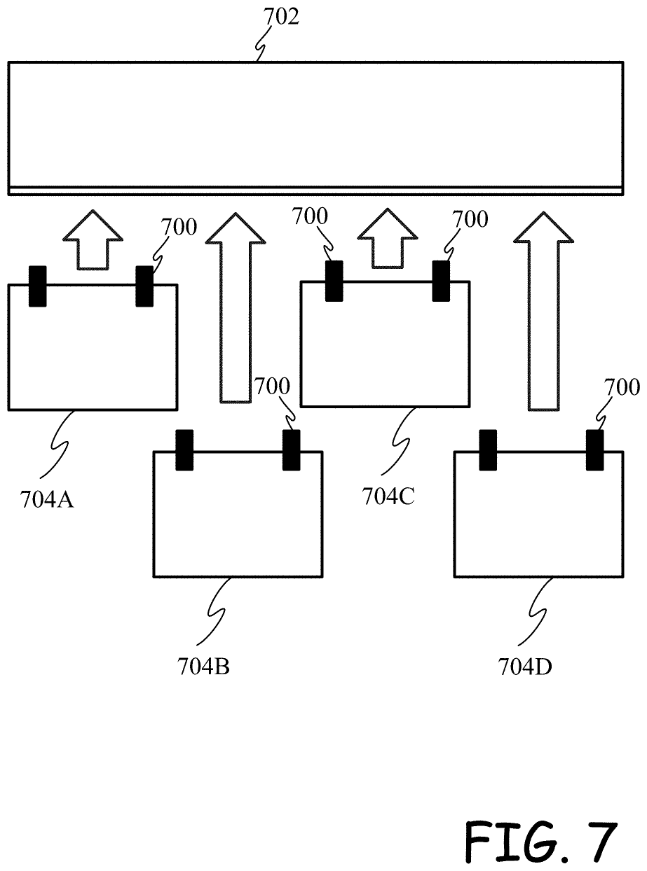

FIG. 7 is a conceptual diagram of another embodiment of the no-access food guard shield system. In this embodiment, a plurality of drop down panels 704A-D, each including one or more bracket systems 700 are illustrated. Although only 4 are illustrated, it should be appreciated that more or fewer such drop down panels may be utilized in various applications. Advantageously, in this embodiment, drop down panels 704 of varying sizes can be manufacture and sold as complete units, fully equipped with pre-installed brackets or installable brackets. Thus, a customer that has an installed food guard system of length L, can purchase one or more of the installable panels of length M, where M<or=L, and install them in an overlapping manner on an existing main viewing panel 702. The manufacture may offer one or more different panel lengths to facilitate creating complete coverage of the serving area. For example, if the manufacture offers panels of size M, N and P, a user could purchase a set of panels such that the summation of the lengths of the panels, taking consideration an overlap (i.e. of one or two inches plus or minus) is equal to the length L of the main viewing panel. As a non-limiting example, suppose M=48 inches, N=24 inches and P=12 inches, but each includes an additional 1 inch on each side for overlap (i.e., the actual length would be 50 inches, 26 inches and 14 inches respectively). Thus, if the user has a pre-installed food guard system where the length L is equal to 84 inches, the user can purchase one M, one N and one P sized panels, and overlap them to create a total of 84 inches. Or, if the user has a long buffet that includes a main viewing panel of length L=192 inches, the user could purchase four 48 inch drop down panels, similar to the structure in FIG. 7, and install them in an overlapping manner to fully cover the existing system.

Systems and methods for a bracket system for retrofit of a drop shield to a main viewing panel of a food guard have been described using detailed descriptions of embodiments thereof that are provided by way of example and are not intended to limit the scope of the disclosure. The described and illustrated embodiments comprise different features, not all of which are required in all embodiments of the solution. Some embodiments of the solution utilize only some of the features or possible combinations of the features. Variations of embodiments of the solution that are described and embodiments of the solution comprising different combinations of features noted in the described embodiments will occur to persons of the art.

It will be appreciated by persons skilled in the art that a system or method for a bracket system for retrofit of a drop shield to a main viewing panel of a food guard according to the solution is not limited by what has been particularly shown and described herein above. Rather, the scope of the disclosed solution is defined by the claims that follow.

What is claimed is:

1. A system for attaching food guard panels, the system comprising:
a first attachment device that is configured to be secured to a first panel;
a second attachment device secured to a second panel; and
an adjustable hinge configured to couple the first attachment device to the second attachment device such that the first panel and the second panel can be held at a desired angle relative to each other;
whereby the first attachment device holds the first panel over an area to be protected and the second attachment device holds the second panel in front of an area such that access to the area is restricted.

2. The system of claim 1, wherein the first attachment device further comprises:
a first holder that defines a first channel for receiving the first panel;
one side of the first holder defining one or more apertures; and
one or more securement elements that are inserted through the one or more apertures and used to bias the first panel against an opposing side of the first holder to secure the first panel in position.

3. The system of claim 2, wherein the second attachment device further comprises:
a second holder that defines a second channel for receiving the second panel;
one side of the second holder defining one or more apertures; and
one or more securement elements that are inserted through the one or more apertures and used to bias the second panel against an opposing side of the second holder to secure the second panel in position.

4. The system of claim 3, wherein the adjustable hinge comprises one or more flanges on the first attachment device and one or more flanges on the second attachment device, wherein each of the flanges define an aperture and each of the apertures can be aligned with each other and are configured to receive a rod.

5. The system of claim 4, wherein the rod includes one or more tightening nuts wherein the hinge can be secured in one or more positions by tightening the one or more nuts.

6. The system of claim 5, wherein the second panel can be adjusted relative to the first panel by loosening the one or more nuts, pivoting the hinge to a new position, then re-tightening the nuts.

7. The system of claim 5, wherein the hinge further comprises a spring configured to bias the first attachment device towards a first position but configured to allow the first attachment device to be moved towards a second position.

8. The system of claim 5, wherein the hinge further comprises a spring configured to bias the second attachment device towards a first position but configured to allow the second attachment device to be moved towards a second position.

9. The system of claim 5, wherein the hinge further comprises a first spring configured to bias the first attachment device towards a first position but configured to allow the second attachment device to be moved towards a second position and a second spring configured to bias the second attachment device towards a third position but configured to allow the second attachment device to be moved towards a fourth position.

10. The system of claim 1, wherein the second attachment device further comprises:
a second holder that defines a second channel for receiving the second panel;
one side of the second holder defining one or more apertures; and
one or more securement elements that are inserted through the one or more apertures and used to bias the second panel against an opposing side of the second holder to secure the second panel in position.

11. The system of claim 1, wherein the second attachment device further comprises a second holder that is fixedly attached to the second panel.

12. A method for attaching food guard panels, the method comprising:
securing one or more second attachment devices to a drop down panel;
securing one or more first attachment devices to an existing main viewing panel of a food guard system, wherein each of the one or more second attachment devices are hingedly coupled to one of the one or more of the first attachment devices, whereby the drop down panel is attached to the main viewing panel; and
adjusting the angle of the drop down panel relative to the main viewing panel to prevent access to items under the main viewing panel.
whereby the first attachment device holds the first panel over an area to be protected and the second attachment device holds the second panel in front of an area such that access to the area is restricted.

13. The method of claim 12, wherein the step of securing one or more second attachment devices to the drop down panel comprises inserting the drop down panel into a channel of the one or more second attachment devices and tightening a set screw to secure the drop down panel within the channel by friction.

14. The method of claim 12, wherein the step of securing one or more second attachment devices to the drop down panel comprises setting the drop down panel onto a surface of the one or more second attachment devices and bolting the drop down panel to the surface.

15. The method of claim 12, wherein the step of securing one or more second attachment devices to the drop down panel comprises setting the drop down panel onto a surface of the one or more second attachment devices and using adhesive to secure the drop down panel to the surface.

16. The method of claim 12, wherein the step of securing one or more first attachment devices to the main viewing panel, wherein each of the one or more first attachment devices includes a channel for receiving the main viewing panel, comprises sliding the channel of the one or more first attachment devices on to the main viewing panel, and using one or more securement elements that are inserted through one or more apertures in the one or more first attachment devices, to bias the main viewing panel against an interior side of the channel to secure each of the one or more first attachment devices to the main viewing panel.
